(19) United States
(12) Patent Application Publication
(10) Pub. No.: US 2010/0091085 A1
(43) Pub. Date: Apr. 15, 2010

(54) AUGMENTING TV MENU ICON WITH IMAGES IN FRONT OF TV

(75) Inventors: Travis Baurmann, San Diego, CA (US); Thomas Patrick Dawson, Escondido, CA (US); Steven Friedlander, San Diego, CA (US); Seth Hill, La Mesa, CA (US)

Correspondence Address: ROGITZ & ASSOCIATES, 750 B STREET, SUITE 3120, SAN DIEGO, CA, 92101, US

(73) Assignee: SONY CORPORATION and SONY ELECTRONICS INC.

(21) Appl. No.: 12/251,755

(22) Filed: Oct. 15, 2008

(51) Int. Cl. H04N 7/15; H04N 5/222

(52) U.S. Cl. 348/14.08; 348/333.01; 348/E07.083; 348/E05.022

(57) ABSTRACT

Images of space including objects in front of a TV that are generated by a camera on the TV are superimposed as reflections on user interface elements such as but not limited to menu icons presented on the TV screen.

### FIELD OF THE INVENTION

The present document relates generally to augmenting TV menu elements with reflections of images in front of the TV.

### BACKGROUND OF THE INVENTION

TV menus increasingly include icons representing selectable content or activities. Also, TVs can be expected to increasingly include on board cameras for, e.g., video conferencing purposes. With these recognitions in mind, present principles are advanced hereunder.

### SUMMARY OF THE INVENTION

A television has a chassis, a video display supported on the chassis, and a camera associated with the chassis for generating images. A processor in the chassis presents user interface elements on the display. The elements are selectable using a remote control to input commands to the processor. A computer readable storage medium is accessible to the processor and bears instructions to cause the processor to superimpose a representation of the image on an element.

In some embodiments the representation is not an exact facsimile of the image. For example, the representation can emulate a reflection of the image and may be of a lower resolution than the image. Respective representations of the image can be presented on all elements presented on the display.

In another aspect, a method includes imaging space in front of a TV, and superimposing a computer-generated reflection of the space on menu elements presented on the TV.

In another aspect, a system includes a TV including a TV display and a camera positioned to generate an image of space in front of the display. A processor is associated with the TV for presenting at least one element on the TV. A representation of the image of space in front of the television is shown on the display as a set of reflections on various elements of the user interface.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of an example non-limiting TV that may embody present principles;

FIG. 2 is a schematic view illustrating a person occupying space in front of a TV and showing the TV screen displaying graphical user interface (GUI) icons with reflections on each icon derived from an image of the person; and

FIG. 3 is a flow chart of example non-limiting logic in accordance with present principles.

### DETAILED DESCRIPTION OF THE PREFERRED EMBODIMENT

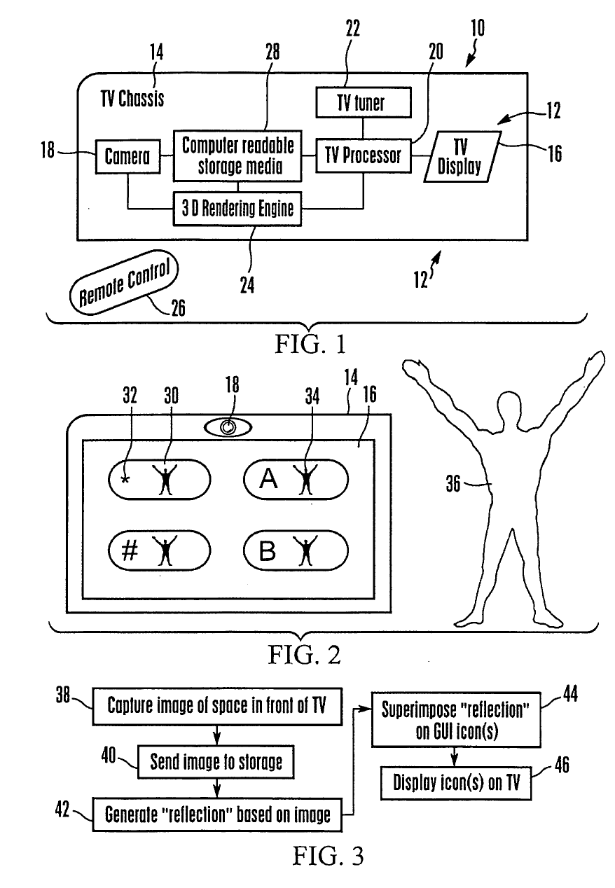

Referring initially to FIG. 1, a system is shown, generally designated 10, that includes a TV 12 embodied by a TV chassis 14 supporting a TV display 16. A camera 18 such as a digital video or still camera may be associated with the TV 12 by, e.g., mounting the camera 18 on the chassis 14.

Typically, a TV processor 20 is inside the chassis 14 and may receive TV signals from a TV tuner 22 that may also be inside the chassis 14 or in a separately housed set-top box. The processor 20 causes TV programming to be displayed on the display 16, which may be, without limitation, a flat panel display, matrix display, cathode ray tube, in standard and/or high definition.

Additionally, a graphics rendering engine 24, preferably but not exclusively a three dimensional graphics rendering engine, may be associated with the TV 12 by, e.g., mounting the engine 24 in the chassis 14. The graphics engine 24 may be a software-implemented engine executed by the TV processor 20 or it may be a hardware-implemented processor. In any case, the graphics engine 24 may communicate with the TV processor 20. Among other things, the rendering engine 24 renders graphics such as 3D graphics in the form of user interface icons that are presented on screen and that can be selected by a person using, e.g., a point and click device such as but not limited to a wireless remote control 26 as a means of entering commands represented by the icons into the processor 20 and/or engine 24.

Image information from the camera 18 can be provided to the TV processor 20 and/or to the graphics engine 24 in accordance with disclosure below. The image information may be stored on one or more computer readable storage media 28, with the processor 20 and/or engine 24 accessing the media 28. Without limitation the medium or media 28 may be disk-based storage, solid state storage, or other appropriate storage, and in the example non-limiting embodiment shown the media 28 is disposed in the chassis 14. Additionally, some or all of the logic described below in reference to FIG. 3 may be embodied as computer-executable instructions on the media 28.

FIG. 2 shows example non-limiting user interface icons 30 that may be presented on the display 16. As shown, each icon 30, which may be a 3D icon, typically includes user interface indicia 32, e.g., words indicating a desired action or program or a thumbnail image of an available TV program, etc.

Furthermore, a representation 34 of an image of space that is imaged by the camera 18, typically space in front of the TV, can be displayed on at least one and preferably on all of the icons 30 as shown. In the example shown, a person 36 is imaged by the camera 18 and so the representations 34 are of the person, in this example showing a figure with upraised hands. If desired, as objects in the space imaged by the camera 18 change, the representations 34 correspondingly change.

As may be appreciated in reference to FIG. 2, the representations 34 may not be exact facsimiles of the image of the person 36. Instead, the representations 34 can emulate a reflection of the person's image and thus may be of a lower resolution than the image produced by the camera 18.

With greater specificity and now referring to FIG. 3, at block 38 the camera 18 captures an image typically of objects in space in front of the TV and if desired may send the image to the storage medium 28 at block 40. Then, at block 42 the graphics engine 24 or, in some embodiments, the TV processor 20 if desired, derives a representation of the image. In a preferred non-limiting embodiment the representation is a reflection of the image.

By way of example, the graphics engine 24 may generate from the image a perfect scattered reflection of the image, and/or a specular reflection of image, and/or a combination of the two. In some embodiments ray tracing principles known in the art may be used. U.S. Pat. No. 6,774,896, incorporated herein by reference in its entirety, provides non-limiting example discussion of image reflection derivation. In any case, it may now be appreciated that the representations 34 of the person 36 that are presented on the icons 30 in FIG. 2 make it appear as though the person 36 is reflected in the icons. In other words, the representations 34 as a level of realism to allow the image of the room in front of the TV to be part of the reflective look of the TV user interface.

Proceeding to block 42, the representations 34 are combined onto the icons 30 by, e.g., superimposing a respective representation 34 on respective icon indicia 32. Block 46 simply indicates that state of the icons 30 being displayed on the display 18.

The above process can update in real time. For example, as the camera 18 captures the person 36 moving, the representations 34 on the icons 30 can correspondingly move.

In example implementations the image data taken from the camera 18 updates the image data used by the graphics engine 24 that represents the reflection map applied to surfaces within the icons 30 of the TV's user interface. As mentioned above, the entire image may be applied across all icons 30 to provide the reflective surface for each icon or other element in the menu. Alternatively, subsets of the input image can be applied to menu elements based on their relative position and orientation. This second approach spreads portions of the reflection across the menu elements to provide a more realistic appearance. Thus, as a person walks in front of the TV, his reflection will move across the realistically rendered user interface elements, e.g., the icons 30.

While the particular AUGMENTING TV MENU ICON WITH IMAGES IN FRONT OF TV is herein shown and described in detail, it is to be understood that the subject matter which is encompassed by the present invention is limited only by the claims.

What is claimed is:

1. Television, comprising:
chassis;
video display supported on the chassis;
camera associated with the chassis and generating at least one image;
processor in the chassis configured to present user interface elements on the display, the elements being selectable using a point and click device to input commands to the processor; and
computer readable storage medium accessible to the processor and bearing instructions to cause the processor to superimpose a representation of the image on at least one element.

2. The television of claim 1, wherein the representation is not an exact facsimile of the image.

3. The television of claim 1, wherein the representation emulates a reflection of the image.

4. The television of claim 1, wherein the representation is of a lower resolution than the image.

5. The television of claim 1, wherein respective representations of the image are presented on all or selected elements presented on the display.

6. Method comprising:
imaging space in front of a TV; and
superimposing a computer-generated reflection of the space on menu elements presented on the TV.

7. The method of claim 6, wherein an image of the space is generated by a camera on the TV.

8. The method of claim 7, wherein the reflection is not an exact facsimile of the image.

9. The method of claim 7, wherein the reflection is of a lower resolution than the image.

10. The method of claim 6, wherein respective reflections of the space are presented on at least selected elements presented on the TV.

11. System comprising:
a TV including a TV display;
a camera positioned to generate an image of space in front of the display; and
a processor associated with the TV for presenting at least one element on the TV, a representation of the image being displayed on the element.

12. The system of claim 11, wherein a user interface image is presented on at least one element along with the image of space in front of the TV.

13. The system of claim 1, wherein the camera is mounted on the TV.

14. The system of claim 11, wherein the representation is not an exact facsimile of the image.

15. The system of claim 11, wherein the representation emulates a reflection of the image.

16. The system of claim 11, wherein the representation is of a lower resolution than the image.

17. The system of claim 11, wherein respective representations of the image are presented on plural elements presented on the display.
